(19) United States
(12) Patent Application Publication
(10) Pub. No.: US 2006/0250783 A1
(43) Pub. Date: Nov. 9, 2006

(54) Inverter operation modes

(76) Inventors: Bill William F. Taylor, Bend, OR (US); Brian Hoffman, Bend, OR (US)

Correspondence Address: John Vanden Bosche, 6571 Lunde Rd., Everson, WA, 98247, US

(21) Appl. No.: 11/400,786

(22) Filed: Apr. 7, 2006

Related U.S. Application Data
(60) Provisional application No. 60/669,487, filed on Apr. 7, 2005.

(51) Int. Cl. B60Q 1/12

(52) U.S. Cl. 362/42

(57) ABSTRACT

Disclosed herein is a grid interactive inverter capable of multiple modes of operation including: a normal mode for transferring DC power to a utility grid, a constant AC current mode for limiting inverter output, a constant DC voltage mode used for DC testing, and a PV array simulation mode for testing of other inverters in the manufacturing process.

### RELATED APPLICATIONS

This application claims priority under 35 U.S.C. § 119(e) to U.S. Provisional Patent Application No. 60/669,487 which was filed on Apr. 7, 2005. Co-pending patent application Ser. No. 11/187,059 is also incorporated herein by reference.

### FIELD OF THE INVENTION

The invention relates to the modes of operation of an inverter.

### BACKGROUND OF THE INVENTION

The solar energy industry is expanding at a rapid pace. Much of that expansion is due to increases in residential and small commercial photovoltaic (PV) installations. Increasingly these installations are directly connected to the utility grid without the use of batteries. Inverters are the power electronics equipment that converts DC electricity produced by PV panels (collectively a PV array) into AC required by the grid.

Some inverter designs have a bidirectional capability, i.e. power can flow both from a DC side of the inverter to an AC side and vice versa. Battery charging inverters have this capability. Direct grid connected inverters do not require the ability to move power from the AC side to the DC side of the inverter. It would be advantageous for certain testing functions, both at the manufacturing plant and in field testing, if a direct grid tied inverter could controllably allow power to pass from the AC grid to the DC side of the inverter.

### SUMMARY OF THE INVENTION

The present invention is an inverter capable of several modes of operation in addition to its normal operating mode including a constant AC current mode, a constant DC voltage mode, and a photovoltaic (PV) array simulation mode.

Additional features and advantages according to the invention in its various embodiments will be apparent from the remainder of this disclosure.

### BRIEF DESCRIPTION OF THE DRAWINGS

Features and advantages according to embodiments of the invention will be apparent from the following Detailed Description taken in conjunction with the accompanying drawings, in which:

FIG. 1 shows a simplified schematic of a normal operation mode according to the present invention.

FIG. 2 shows a simplified schematic of a constant DC Voltage operation mode according to the present invention.

FIG. 3 shows a simplified schematic of a PV simulation operation mode according to the present invention.

### DETAILED DESCRIPTION OF THE DRAWINGS

An inverter capable of several modes of operation is disclosed herein. Each of the disclosed modes is described separately. Substantially similar modes to those described with variation that could be conceived of by one of skill in the art are included within the scope of this disclosure.

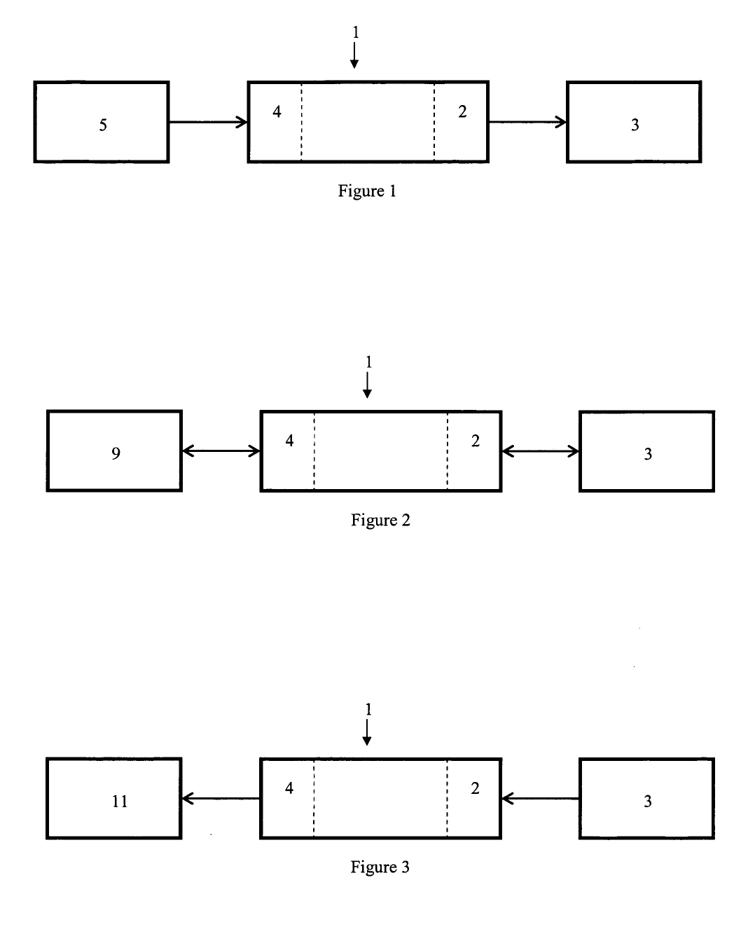

A first mode of operation is a normal operation mode as shown in FIG. 1. Shown is a direct grid tied inverter 1 with an AC side 2 electrically connected to a grid 3. The grid 3 for purposes of this disclosure may be the actual utility grid, stand-alone generator, or a simulated grid using another inverter or AC power supply. Power from a DC source such as a PV array 5 enters a DC side 4 the inverter 1 and then onto the grid 3 through the AC side 2 of the inverter 1. The inverter 1 may optionally employ a maximum power point tracking algorithm that specifies DC voltage to maximize power production by the PV array 5. In the normal operation mode electrical power is controlled to prevent flow from the AC side 2 to the DC side 4 of the inverter 1 unless the inverter 1 is also capable of charging batteries.

It should be noted that within this disclosure the terms ‘AC side’ and ‘DC side’ refer to electrical ‘sides’ of an inverter and not necessarily to a physical location on an inverter. DC power enters the DC side 4 of an inverter 1, is processed by the inverter 1, and converted to AC power that leaves the AC side 2 of the inverter 1. Conversely AC power may enter the AC side 2 be and be converted by the inverter 1 to DC power passing out the DC side 4. An inverter 1 is any device that converts DC power to AC power. Typically, an inverter 1 has a digital signal processor which sends commands to transistors (such as IGBTs or MOSFETs) such that the amount of power flowing between the AC side and DC side can be controlled.

A second mode of operation is a constant DC Voltage mode shown in FIG. 3. In the constant DC voltage mode a test object 9 is electrically connected to the DC side 4 of an inverter 1. The test object 9 may be another inverter undergoing factory testing, a PV array undergoing field testing, or some other device at which a constant DC voltage is desired. For instance, a PV array can be checked for correct wiring by observing if the current flow at various set DC voltages is close to that specified by the PV panel manufacturer. The inverter 1 maintains a constant DC voltage on the DC side 4 allowing power to flow from or onto the grid 3, and to or from the test object 9 as necessary to maintain a user set-point voltage.

A third mode of operation is a PV Simulation mode shown in FIG. 3. In this mode, power from the grid 3 is used by the inverter 1 to simulate a PV array on its DC side 4. The DC side is connected to a DC load 11. The DC load is likely another inverter being tested but could be another DC load such as a PV charge controller, or a DC powered device such as a solar water pump. In PV simulation mode a control algorithm in the inverter 1 maintains a voltage and limits current at the DC side 4 in a way that is substantially similar to the voltage-current characteristics of a PV array. The user of the inverter 1 may optionally specify set points such as array size and type, temperature, and insolation. The PV simulation mode is especially valuable in design, test, and manufacturing of inverters 1 since one inverter can provide the test input for another. In PV Simulation mode, electrical power is not allowed to flow from the DC side 4 to the AC side 2 of the inverter 1. In this way, it is possible to run hundreds of solar inverters for test purposes without a need for hundreds of solar arrays.

There are multiple implementations of hardware and software possible to achieve the modes of operation disclosed above as will be evident to one skilled in the art. As such, no specific device for achieving the above-disclosed modes of operation is herein described, as all such devises are within the scope of this disclosure

While modes of the invention have been shown and described, it will be apparent to those skilled in the art that various modifications may be made without departing from the scope of the invention. Therefore, it is intended that the invention not necessarily be limited to the specific embodiment described and illustrated herein.

What is claimed is:

1. An inverter that connects a photovoltaic panel to an AC utility grid comprising:
a set of transistors that convert DC power to AC power;
a digital signal processor that controls said transistors; and
a control algorithm that controls said transistors to operate in normal operation mode as well as at least one user selectable test mode.

2. The inverter of claim 1 wherein said at least one test mode comprises a constant DC voltage mode in which power is allowed to flow either from a DC side of said inverter to an AC side or said inverter or from said AC side to said DC side as required to maintain a substantially constant voltage on said DC side of said inverter.

3. The inverter of claim 2 wherein said constant DC voltage mode is used to test for proper installation of a photovoltaic panel that is electrically connected to the DC side of said inverter.

4. The inverter of claim 1 wherein said at least one test mode comprises a PV simulation mode.

5. The inverter of claim 4 wherein said inverter maintains voltage and limits current at the DC side of said inverter in a way that is substantially similar to the voltage-current characteristics of a PV array.

6. The inverter of claim 2 wherein said at least one test mode comprises a PV simulation mode.

7. The inverter of claim 6 wherein said inverter maintains voltage and limits current at the DC side of said inverter in a way that is substantially similar to the voltage-current characteristics of a PV array.

8. A method of operating an inverter for a batteryless photovoltaic system comprising the steps of:
providing a set of transistors that convert DC power to AC power;
providing a digital signal processor that controls said transistors; and
controlling said transistors to operate in normal operation mode as well as at least one user selectable test mode.

9. The method of claim 8 wherein controlling said transistors to operate in said at least one of said test modes comprises controlling said transistors to operate in a constant DC voltage mode which comprises allowing power to flow either from a DC side of said inverter to an AC side or said inverter or from said AC side to said DC side as required to maintain a substantially constant voltage on said DC side of said inverter.

10. The inverter of claim 9 wherein said transistors are controlled to operate in said constant DC voltage mode to test for proper installation of a photovoltaic panel that is electrically connected to the DC side of said inverter.

11. The inverter of claim 8 wherein controlling said transistors to operate in said at least one of said test modes comprises controlling said transistors to operate in a PV simulation mode.

12. The inverter of claim 11 wherein controlling said transistors to operate in said PV simulation mode comprises maintaining voltage and limiting current at the DC side of said inverter in a way that is substantially similar to the voltage-current characteristics of a PV array.

13. The inverter of claim 9 wherein controlling said transistors to operate in said at least one of said test modes comprises controlling said transistors to operate in a PV simulation mode.

14. The inverter of claim 13 wherein controlling said transistors to operate in said PV simulation mode comprises maintaining voltage and limiting current at the DC side of said inverter in a way that is substantially similar to the voltage-current characteristics of a PV array.
